(19) United States
(12) Patent Application Publication
(10) Pub. No.: US 2026/0202960 A1
(43) Pub. Date: Jul. 16, 2026

(54) ELECTRONIC DEVICE INCLUDING AT LEAST ONE KEY, CONTROL METHOD THEREOF, AND NON-TRANSITORY COMPUTER-READABLE RECORDING MEDIUM

(71) Applicant: SAMSUNG ELECTRONICS CO., LTD., Suwon-si (KR)

(72) Inventors: Nahye KIM, Suwon-si (KR); Sunwoong HAM, Suwon-si (KR); Wonkyu SUNG, Suwon-si (KR); Daekwang JUNG, Suwon-si (KR); Yunsu CHO, Suwon-si (KR)

(21) Appl. No.: 19/556,678

(22) Filed: Mar. 4, 2026

Related U.S. Application Data
(63) Continuation of application No. PCT/KR2024/014357, filed on Sep. 24, 2024.

(30) Foreign Application Priority Data
Oct. 4, 2023 (KR) 10-2023-0131914
Nov. 30, 2023 (KR) 10-2023-0171683

(51) Int. Cl. G06F 3/0488; G06F 3/01; G06F 3/044; G06F 3/0482

(52) U.S. Cl. CPC G06F 3/0488; G06F 3/016; G06F 3/0446; G06F 3/0445; G06F 3/0482; G06F 2203/04105

(57) ABSTRACT

An electronic device includes a housing having a front surface and at least one side surface, a display mounted on the front surface, an input unit disposed on the at least one side surface and configured to receive a user input for touch and pressure, at least one processor including processing circuitry, and memory storing executable instructions that, when executed by the at least one processor individually or collectively, cause the electronic device to perform operations. The instructions are configured to, when executed by the at least one processor, cause the electronic device to: display an execution screen of a first application on the display, identify a direction of a touch and an intensity of a pressure of a user input as identified information if the user input is received through the input unit, and control the execution screen of the first application on the basis of the identified information.

### CROSS-REFERENCE TO RELATED APPLICATIONS

This application is a continuation application under, 35 U.S.C. §111(a), of International Patent Application No. PCT/KR2024/014357, filed on September 24, 2024, which claims priority to Korean Patent Application No. 10-2023-0131914, filed on October 4, 2023, and Korean Patent Application No. 10-2023-0171683, filed on November 20, 2023, the content of which in their entirety is herein incorporated by reference.

### BACKGROUND

### 1. Field

Embodiments of the disclosure relate to an electronic device including at least one key, a control method thereof, and a non-transitory computer-readable recording medium.

### 2. Description of Related Art

More and more services and additional functions are being provided through electronic devices, e.g., smartphones, or other portable electronic devices. To meet the needs of various users and raise use efficiency of electronic devices, communication service carriers or device manufacturers are competing to develop electronic devices with differentiated and diversified functionalities. Accordingly, various functions that are provided through electronic devices are evolving.

An electronic device may include a physical key (or hardware key/button) exposed to the outside of the electronic device (e.g., a key including a tact dome switch). For example, the electronic device may obtain an input pressing (or touching) a physical key exposed to the outside of the electronic device from a user.

In electronic devices, attempts are being made to replace physical keys exposed to the outside of the electronic device with virtual keys (or software keys) displayed through a display. For example, in an electronic device, a home key for performing a designated function while the electronic device is in a power on state may be implemented as a virtual key, replacing a physical key.

The above-described information may be provided as related art for the purpose of helping understanding of the disclosure. No claim or determination is made as to whether any of the foregoing is applicable as background art in relation to the disclosure.

### SUMMARY

According to an embodiment, an electronic device includes a housing having a front surface and at least one side surface, a display mounted on the front surface of the housing, an input unit disposed on the at least one side surface of the housing and configured to receive a user input for touch and pressure, where the input unit includes a touch-sensitive surface configured to detect touch location and direction and a pressure-sensitive layer configured to measure applied pressure intensity, at least one processor including processing circuitry, and memory storing executable instructions that, when executed by the at least one processor individually or collectively, cause the electronic device to perform operations.

According to an embodiment, the instructions are configured to, when executed by the at least one processor individually or collectively, to cause the electronic device to display an execution screen of a first application on the display.

According to an embodiment, the instructions are configured to, when executed by the at least one processor individually or collectively, cause the electronic device to identify a direction of a touch and an intensity of a pressure of a user input as identified information when receiving the user input through the input unit.

According to an embodiment, the instructions are configured to, when executed by the at least one processor individually or collectively, cause the electronic device to control the execution screen of the first application based on the identified information.

According to an embodiment, a control method of an electronic device includes displaying an execution screen of a first application on a display of the electronic device.

According to an embodiment, the control method of the electronic device includes, when receiving a user input through the input unit of the electronic device, identifying a direction of a touch and an intensity of a pressure of the user input as identified information.

According to an embodiment, the control method of the electronic device includes controlling the execution screen of the first application based on the identified information.

According to an embodiment, a computer program product includes a non-transitory computer-readable recording medium storing instructions configured to be executed by at least one processor of an electronic device to perform operations including displaying an execution screen of a first application on a display of the electronic device.

According to an embodiment, the instructions are configured to cause the electronic device to identify a direction of a touch and an intensity of a pressure of a user input as identified information when receiving the user input through an input unit of the electronic device.

According to an embodiment, the instructions are configured to cause the electronic device to control the execution screen of the first application based on the identified information.

### BRIEF DESCRIPTION OF DRAWINGS

FIG. 1 is a block diagram illustrating an electronic device in a network environment according to an embodiment.

FIG. 2 is a view illustrating a plurality of keys disposed on a side surface of an electronic device according to an embodiment of the disclosure.

FIG. 3 schematically illustrates a structure of a key according to an embodiment of the disclosure.

FIG. 4A illustrates a simplified structure of a touch sensor according to an embodiment of the disclosure.

FIG. 4B illustrates a simplified structure of a touch sensor according to an embodiment of the disclosure.

FIG. 5 illustrates a simplified configuration of an electronic device according to an embodiment of the disclosure.

FIG. 6 is a flowchart illustrating an operation when a swipe input is received on a key on a side surface of an electronic device according to an embodiment of the disclosure.

FIG. 7 is a view illustrating swipe inputs received on a key on a side surface of an electronic device according to an embodiment of the disclosure.

FIG. 8 is a flowchart illustrating an operation of an electronic device according to a direction of a swipe input received on a key on a side surface of the electronic device according to an embodiment of the disclosure.

FIG. 9 is a view illustrating an operation of an electronic device according to a direction of a swipe input received on a key on a side surface of the electronic device according to an embodiment of the disclosure.

FIG. 10 is a view illustrating an operation of an electronic device according to a direction of a swipe input received on a key on a side surface of the electronic device while an always on display (AOD) screen is displayed according to an embodiment of the disclosure.

FIG. 11A is a view illustrating an operation of an electronic device according to a direction of a swipe input received on a key on a side surface of the electronic device in a locked state according to an embodiment of the disclosure.

FIG. 11B is a view illustrating a screen for setting a swipe direction of a key on a side surface of an electronic device for unlocking the electronic device according to an embodiment of the disclosure.

FIG. 12 is a view illustrating an operation of an electronic device according to a user input received on a key on a side surface of the electronic device during video playback according to an embodiment of the disclosure.

FIG. 13 is a view illustrating an operation of an electronic device according to a pressure value of a swipe input received on a key on a side surface of the electronic device according to an embodiment of the disclosure.

FIG. 14 is a view illustrating an operation of an electronic device providing a user interface related to a function based on a set order according to a swipe input received on a key on a side surface of the electronic device according to an embodiment of the disclosure.

FIG. 15 is a view illustrating vibration feedback provided according to a user input received on a key on a side surface of an electronic device according to an embodiment of the disclosure.

FIG. 16 is a view illustrating vibration feedback provided according to a user input received on a key on a side surface of an electronic device according to an embodiment of the disclosure.

FIG. 17 is a view illustrating an operation of providing vibration corresponding to heart rate information through a key on a side surface of an electronic device according to an embodiment of the disclosure.

### DETAILED DESCRIPTION

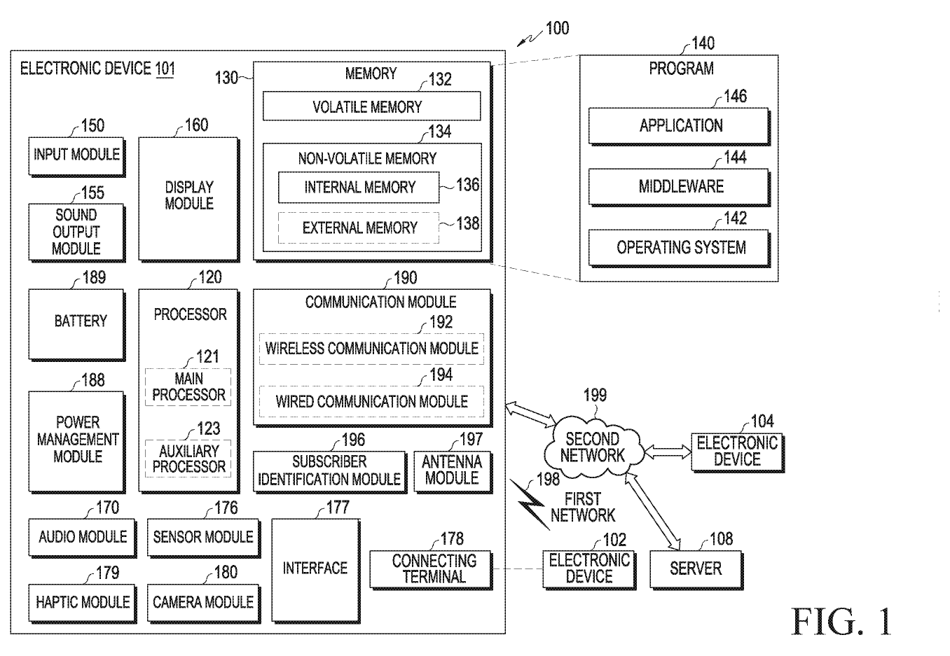

FIG. 1 is a block diagram illustrating an electronic device 101 in a network environment 100 according to an embodiment. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth^{TM}, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

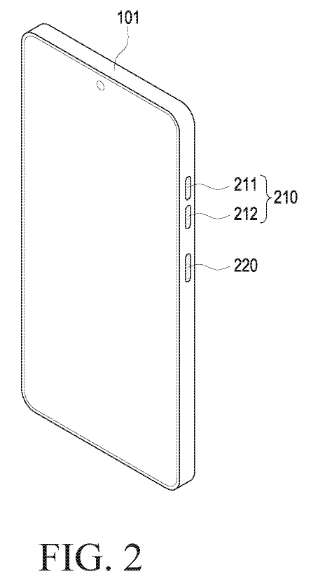

FIG. 2 is a view illustrating a plurality of keys disposed on a side surface of an electronic device according to an embodiment of the disclosure.

Referring to FIG. 2, an electronic device 101 (e.g., the electronic device 101 of FIG. 1) may include a first input unit 210 and a second input unit 220. According to an embodiment, the electronic device 101 may include the first input unit 210 and the second input unit 220 disposed in a region of a housing on a side surface of the electronic device 101. For example, the first input unit 210 and the second input unit 220 may be in the form of buttons protruding from the housing, or may be in a flat buttonless form with no height difference from the housing.

According to an embodiment, the first input unit 210 may receive inputs at an upper portion 211 and a lower portion 212, respectively. For example, the upper portion 211 and the lower portion 212 may be divided at a 50% position in the y-axis direction of the first input unit 210.

According to an embodiment, the first input unit 210 may be used to adjust setting values within a specific application, such as, for example, volume control, brightness control, or camera zoom function. For example, when touching or swiping upward or downward on the upper portion 211 or lower portion 212 of the first input unit 210, or maintaining a touch and then moving upward or downward, the corresponding function may be controlled.

According to an embodiment, the second input unit 220 may perform a power or screen on/off, Bixby call, execution of camera or payment functions, or quick execution of a user-designated application. According to an embodiment, when touching, swiping upward or downward on the second input unit 220, or maintaining a touch and then moving upward or downward, the corresponding function may be controlled.

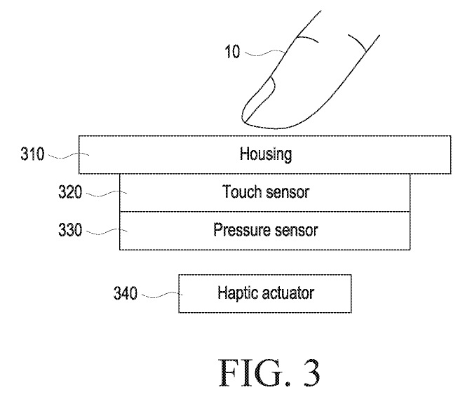

FIG. 3 schematically illustrates a structure of a key (which may also be referred to as a button or switch) according to an embodiment of the disclosure.

Referring to FIG. 3, an input unit (e.g., the first input unit 210 of FIG. 2 or the second input unit 220 of FIG. 2) may include a housing 310, a touch sensor 320 (e.g., the sensor module 176 of FIG. 1), a pressure sensor 330 (e.g., the sensor module 176 of FIG. 1), and a haptic actuator 340.

According to an embodiment, the housing 310 may have a key area indicated through buttons, embossing, or engraving, or may not have a key area indicated.

According to an embodiment, a user input 10 may be received through an outer surface of the housing. According to an embodiment, the electronic device may detect the user input 10 through the touch sensor 320 and pressure sensor 330 disposed on an inner surface of the housing 310.

According to an embodiment, the touch sensor 320 and the pressure sensor 330 may be disposed in an overlapping manner in order, or may be disposed side by side under the housing 310.

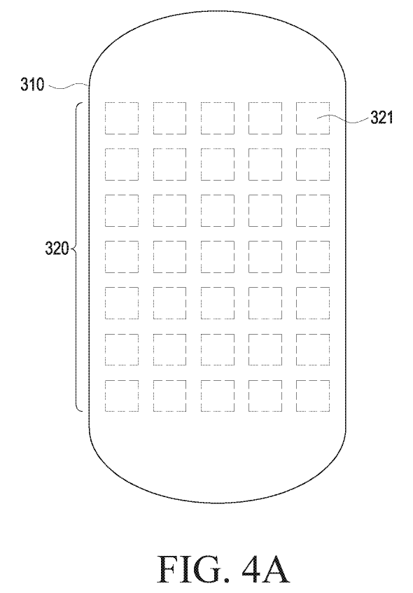

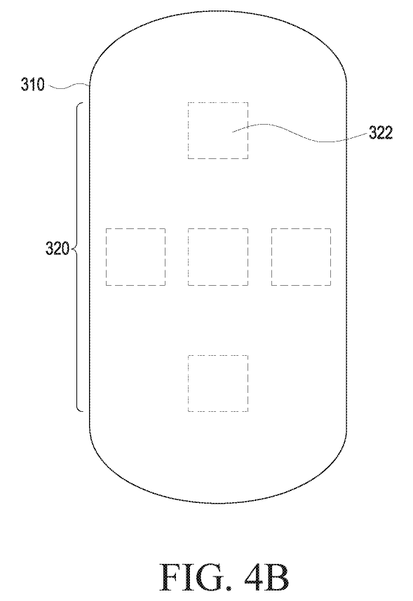

According to an embodiment, the touch sensor 320 may be implemented in a capacitive or ultrasonic method. According to an embodiment, the capacitive touch sensor 320 is described below in more detail with reference to FIG. 4A. According to an embodiment, the ultrasonic touch sensor 320 is described below in more detail with reference to FIG. 4B.

According to an embodiment, the pressure sensor 330 may be of a capacitive, inductive, strain gauge, or piezo type.

A capacitive pressure sensor 330 may detect pressure based on changes in capacitance formed between two electrodes with a dielectric between them according to the pressure of a user input. The capacitance may increase as the distance between the two electrodes decreases due to user pressure.

An inductive pressure sensor 330 may detect pressure based on changes in current induced in an inductor (e.g., a coil) according to the pressure of a user input. The current may increase as a conductor (e.g., a metal housing or a user's finger) approaches the inductor (e.g., a coil) disposed inside the housing due to the pressure of a user input.

A strain gauge pressure sensor 330 may detect pressure based on changes in resistance of a conductor according to the pressure of a user input. The resistance may increase as the cross-sectional area of the conductor decreases as the length of the conductor increases due to the pressure of a user input.

A piezo pressure sensor 330 may detect pressure based on current or voltage difference generated by piezo material according to the pressure of a user input. The current or voltage difference may increase as the amount of current converted by the piezo material increases according to the pressure of a user input.

According to an embodiment, the haptic actuator 340 may provide vibration to transmit vibration to a user's hand touching the key. For example, the haptic actuator 340 may include a piezo actuator, a horizontal motor, a vertical motor, a sound plate, or a coil motor.

According to an embodiment, the haptic actuator 340 is a component for providing vibration to a key and may be a different component from a haptic actuator that provides vibration to the entire electronic device 101.

According to an embodiment, the haptic actuator 340 may be disposed below the pressure sensor 330, but is not limited thereto, and may be disposed side by side with at least one of the touch sensor 320 or the pressure sensor 330 and disposed below the housing 310.

FIG. 4A illustrates a simplified structure of a touch sensor according to an embodiment of the disclosure.

Referring to FIG. 4A, a key area 410 may be disposed on a housing (e.g., the housing 310 of FIG. 3) on a side surface of an electronic device (e.g., the electronic device 101 of FIG. 1).

According to an embodiment, a touch sensor 320 may be disposed below the key area 410 of the housing. For example, the touch sensor 320 may be of a capacitive type.

According to an embodiment, the touch sensor 320 may include a plurality of electrode pads 321. The plurality of electrode pads 321 may be disposed in a grid form. For example, the plurality of electrode pads 321 may have a structure disposed in one layer or two layers along the X-axis and Y-axis.

According to an embodiment, the capacitive method is a method that determines whether there is a touch by receiving changes in capacitance at the X-axis and Y-axis electrode pads at the position of the touch input when a touch input is received on the surface of the key area 410.

According to an embodiment, since the plurality of electrode pads 321 are disposed at regular intervals in one layer or two layers in the X-axis and Y-axis directions, the electronic device may detect left-right-up-down swipe inputs by comparing the changing capacitance at the X-axis and Y-axis electrode pads at each position when moving in left-right-up-down directions while a touch input is maintained.

According to an embodiment, although FIG. 4A illustrates the plurality of electrode pads 321 disposed in a grid form, the electrode pads 321 may also detect the position of a touch input or swipe input by detecting capacitances at the electrode pad intersection points of a first electrode layer where long electrode pads in a first direction are disposed in a line in a second direction perpendicular to the first direction, and a second electrode layer where long electrode pads in the second direction are disposed in a line in the first direction.

FIG. 4B illustrates a simplified structure of a touch sensor according to an embodiment of the disclosure.

Referring to FIG. 4B, a key area 410 may be disposed on a housing (e.g., the housing 310 of FIG. 3) on a side surface of an electronic device (e.g., the electronic device 101 of FIG. 1).

According to an embodiment, a touch sensor 320 may be disposed below the key area 410 of the housing. For example, the touch sensor 320 may be of an ultrasonic type. According to an embodiment, the ultrasonic method may determine whether there is a touch input based on the intensity of ultrasonic waves that are radiated and then reflected back. For example, when a finger touches the surface of the key area 410, since the intensity of ultrasonic waves reflected from the finger surface is weaker than when the finger is not touched, whether there is a touch input may be determined based on the intensity of the reflected ultrasonic waves.

According to an embodiment, the ultrasonic touch sensor 320 may include a plurality of ultrasonic sensors 322 disposed up, down, left, and right. According to an embodiment, the electronic device may detect the direction of a swipe input based on changes in the intensity of ultrasonic waves detected by each ultrasonic sensor 322.

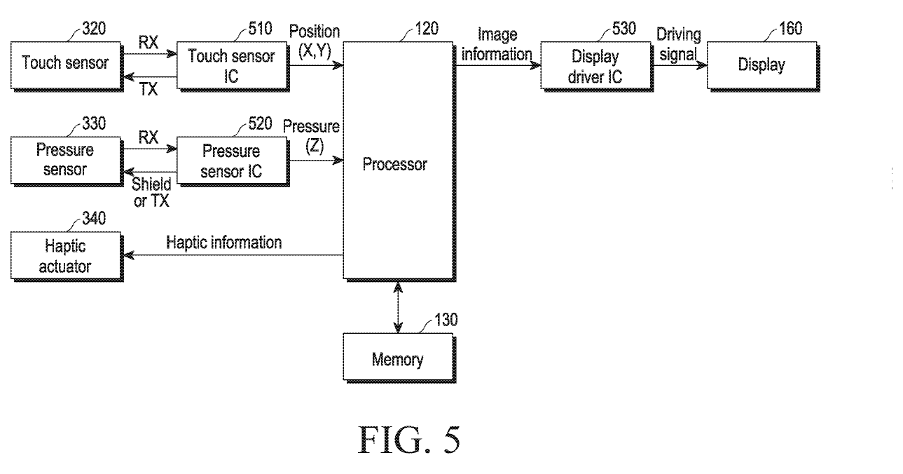

FIG. 5 illustrates a simplified configuration of an electronic device according to an embodiment of the disclosure.

Referring to FIG. 5, an electronic device (e.g., the electronic device 101 of FIG. 1) may include at least one processor 120 (e.g., the processor 120 of FIG. 1), memory (e.g., the memory 130 of FIG. 1), a touch sensor 320 (e.g., the sensor module 176 of FIG. 1 or the touch sensor 320 of FIG. 3), a touch sensor IC 510, a pressure sensor 330 (e.g., the sensor module 176 of FIG. 1 or the pressure sensor 330 of FIG. 3), a pressure sensor IC 520, a display 160 (e.g., the display module 160 of FIG. 1), a display driver IC 530, and a haptic actuator 340 (e.g., the haptic actuator 340 of FIG. 3).

According to an embodiment, the touch sensor IC 510 may transmit or receive signals (transmission signal (TX), reception signal (RX), shield signal, etc.) with the touch sensor 320. The touch sensor IC 510 may detect the position of a user's touch input based on signals transmitted and received with the touch sensor 320. The touch sensor IC 510 may transmit the detected position (e.g., x coordinate, y coordinate) of the touch input to the processor 120.

According to an embodiment, the pressure sensor IC 520 may transmit or receive signals (transmission signal (TX), reception signal (RX), shield signal, etc.) with the pressure sensor 330. The pressure sensor IC 520 may transmit the detected intensity (pressure) of the touch input and/or the duration of pressure to the processor 120. The processor 120 or the pressure sensor IC 520 may determine the intensity (pressure) of the user's touch input and/or the duration of pressure based on the signal received from the pressure sensor 330.

According to an embodiment, the processor 120 may perform the corresponding function based on the position of the touch input received from the touch sensor IC 510 and/or the intensity of the touch input received from the pressure sensor IC 520. For example, the processor 120 may control the display 160 to display the corresponding screen or control the haptic actuator 340 to provide vibration based on the position and/or intensity of the touch input.

According to an embodiment, the processor 120 may determine screen information and position of the screen information to be transmitted to the display driver IC 530. For example, if the intensity of the received touch input is equal to or greater than a first value, the processor 120 may transmit first image information to the display driver IC 530. According to an embodiment, if the intensity of the received touch input is equal to or greater than a second value that is greater than the first value, the processor 120 may transmit second image information to the display driver IC 530.

According to an embodiment, the display driver IC 530 may transmit drive signals (e.g., driver drive signal, gate drive signal, etc.) to the display 160 based on the image information received from the processor 120.

According to an embodiment, the processor 120 may determine haptic information to be transmitted to the haptic actuator 340. For example, if the intensity of the received touch input is equal to or greater than a first value, the processor 120 may transmit first haptic information to the haptic actuator 340. For example, if the intensity of the received touch input is equal to or greater than a second value that is greater than the first value, the processor 120 may transmit second haptic information (e.g., haptic information stronger than the first haptic information) to the haptic actuator 340.

According to an embodiment, the processor 120 may synchronize a first position and a first intensity of a touch input received at a first time, and may synchronize a second position and a second intensity of a touch input received at a second time different from the first time.

According to an embodiment, the memory 130 may store instructions or data for the processor 120 to perform the above-described operations, and may include volatile or non-volatile memory.

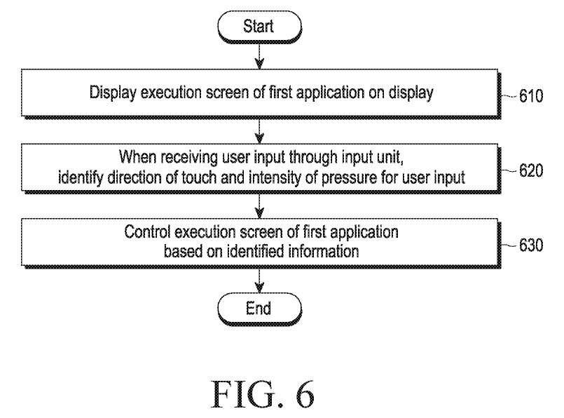

FIG. 6 is a flowchart illustrating an operation when a swipe input is received on a key on a side surface of an electronic device according to an embodiment of the disclosure.

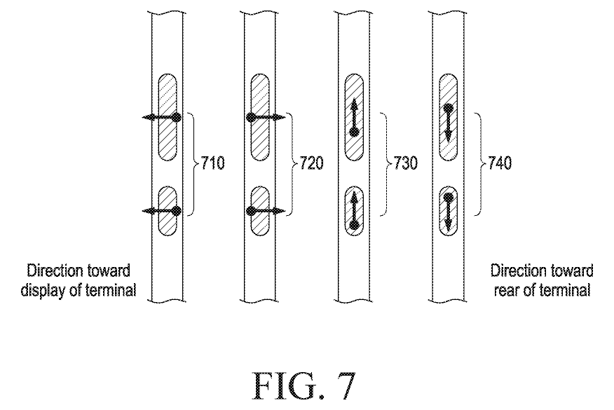

FIG. 7 is a view illustrating swipe inputs received on a key on a side surface of an electronic device according to an embodiment of the disclosure.

Referring to FIG. 6, in operation 610, an electronic device (e.g., the electronic device 101 of FIG. 1 or the processor 120 of FIG. 1) may display an execution screen of a first application on a display (e.g., the display module 160 of FIG. 1).

According to an embodiment, the execution screen of the first application may include a home screen, an always on display (AOD), a lock screen, or an execution screen of a specific application.

According to an embodiment, in operation 620, when receiving a user input through an input unit (e.g., the first input unit 210 of FIG. 2 or the second input unit 220 of FIG. 2), the electronic device may identify a direction of a touch and an intensity of a pressure of the user input as identified information.

For example, the electronic device may recognize input as a press when the input unit is pressed with a force equal to or greater than a specific pressure. For example, the electronic device may recognize input as a double press when the input unit is pressed twice with a force equal to or greater than a specific pressure within a specific time interval. For example, the electronic device may recognize input as n presses when the input unit is pressed n times with a force equal to or greater than a specific pressure within a specific time interval. For example, the electronic device may recognize input as a long press when the input unit is pressed with a force equal to or greater than a specific pressure for more than a specific time. For example, the electronic device may recognize input as a combination press when two or more keys of the input unit are pressed with a force equal to or greater than a specific pressure.

For example, the electronic device may recognize input as a touch when the input unit is contacted with a force below a specific pressure and above a minimum threshold pressure. For example, the electronic device may recognize input as a double touch when the input unit is contacted twice with a force below a specific pressure and above a minimum threshold pressure within a specific time interval. According to an embodiment, the input signal should be separated between the first touch and the subsequent second touch. For example, the electronic device may recognize input as n touches when the input unit is contacted n times with a force below a specific pressure and above a minimum threshold pressure within a specific time interval. According to an embodiment, the input signal should be separated between the first touch and the subsequent second touch.

For example, as illustrated in FIG. 7, the electronic device may recognize input as a swipe front 710 when the surface of the key is swiped from the rear of the electronic device toward the display direction (or +z-axis direction) on the input unit. For example, the electronic device may recognize input as a swipe back 720 when the surface of the key is swiped from the display of the electronic device toward the rear direction (or -z-axis direction) on the input unit. For example, the electronic device may recognize input as a swipe up 730 when the surface of the key is swiped toward the uppermost end of the electronic device (or +y-axis direction) on the input unit. For example, the electronic device may recognize input as a swipe down 740 when the surface of the key is swiped toward the lower surface of the electronic device (or -y-axis direction) on the input unit. According to an embodiment, the electronic device may detect the swipe direction through a touch sensor.

According to an embodiment, the electronic device may identify a pressure value of a user input based on a pressure sensor (e.g., the sensor module 176 of FIG. 1 or the pressure sensor 330 of FIG. 3). For example, the electronic device may identify the pressure value of the user input through a capacitive, inductive, strain gauge, or piezo type pressure sensor.

According to an embodiment, the electronic device may identify the swipe direction of the user input based on changes in the capacitance value of each of a plurality of electrode pads (e.g., the electrode pads 321 of FIG. 4A) of a touch sensor (e.g., the sensor module 176 of FIG. 1, the touch sensor 320 of FIG. 3, the touch sensor 320 of FIG. 4A). For example, the electronic device may identify the direction of a swipe input detected through a capacitive touch sensor (e.g., the touch sensor 320 of FIG. 4A) or an ultrasonic touch sensor (e.g., the touch sensor 320 of FIG. 4B). According to an embodiment, the electronic device may identify whether the swipe direction of the user input is a first direction from the input unit toward the display, a second direction opposite to the first direction, a third direction upward from the input unit, or a fourth direction downward from the input unit, based on changes in the capacitance value of each of the plurality of electrode pads.

According to an embodiment, in operation 630, the execution screen of the first application may be controlled based on the identified information.

According to an embodiment, based on the pressure value being equal to or greater than a first value and the swipe direction being a first direction from the input unit toward the display, the electronic device may overlay and display a user interface including at least one icon corresponding to at least one function respectively on a partial area of the execution screen of the first application. For example, the swipe input in the first direction may be a swipe front input. For example, the at least one function may include execution of a specific application or functions of a specific application (e.g., square capture, circular capture, music playback control, music playlist).

For example, the user interface may be an edge panel including icons each corresponding to at least one function designated by a user. According to an embodiment, the electronic device may execute a function through an icon included in the user interface without executing an application.

According to an embodiment, the user interface may be displayed in the form in which the user interface is located outside the display area and enters into the display area based on a swipe input (e.g., swipe front). For example, based on a user input, the user interface may be displayed in the edge area of the display on the side where the swipe input is received, or may be displayed in the edge area of the display on the opposite side from where the swipe input is received.

According to an embodiment, the user interface may be displayed as a layer above the execution screen of the first application.

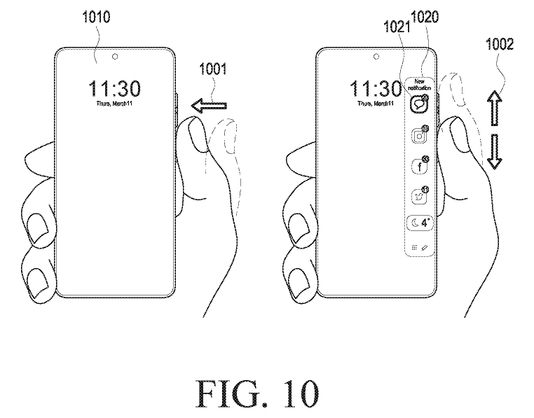

According to an embodiment, when the execution screen of the first application is an AOD screen, the electronic device may display the user interface on a partial area of the AOD screen. According to an embodiment, the operation of displaying the user interface based on a swipe input while the AOD screen is displayed is described below in more detail with reference to FIG. 10.

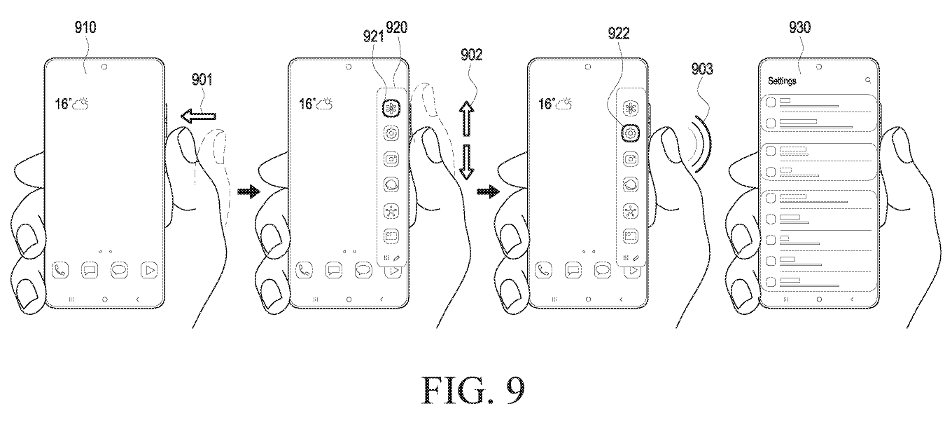

According to an embodiment, the user interface may further include an indicator indicating an icon to be selected among the at least one icon. According to an embodiment, the electronic device may change the position of the indicator based on the swipe direction being a third direction having an angle within a set range from the first direction. For example, the swipe input in the third direction may be a swipe up or swipe down. According to an embodiment, the operation of selecting an icon displayed in the user interface through the input unit is described below in more detail with reference to FIG. 9.

According to an embodiment, when the execution screen of the first application is a lock screen, the electronic device may display the user interface on a partial area of the lock screen. According to an embodiment, the electronic device may display a screen for unlocking based on receiving a user input selecting one icon from the user interface displayed on a partial area of the lock screen.

According to an embodiment, the electronic device may unlock the lock screen based on receiving a plurality of swipe inputs in a set order through the input unit. For example, the order of the plurality of swipe inputs may be preset by a user.

According to an embodiment, the electronic device may display an execution screen of an application for the selected icon. According to an embodiment, as the execution screen of the application for the selected icon is displayed, the display of the user interface may be terminated.

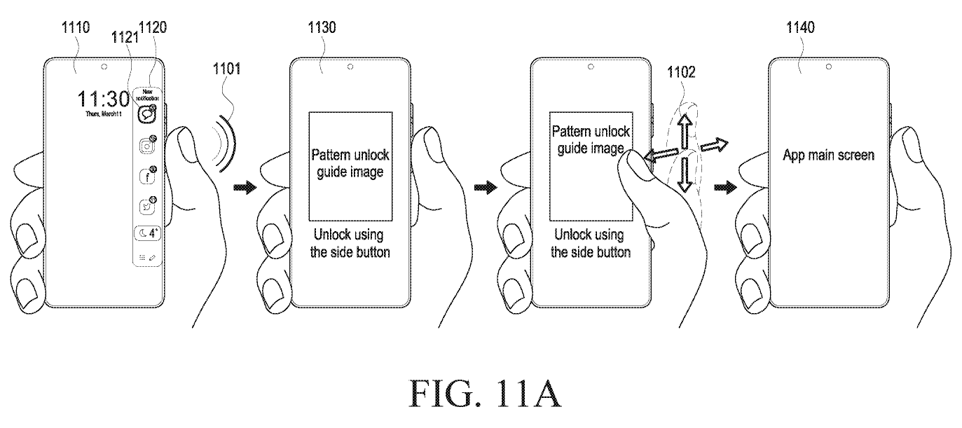

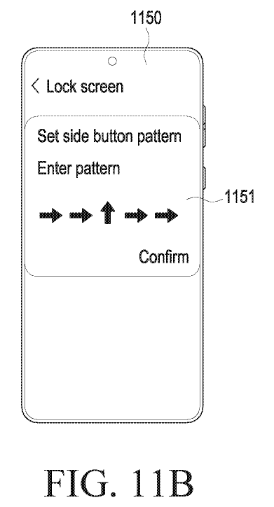

According to an embodiment, the operation of unlocking based on a swipe input on the lock screen is described below in more detail with reference to FIGS. 11A and 11B.

According to an embodiment, the electronic device may display an object related to the user interface based on the pressure value being less than a first value and equal to or greater than a second value. For example, when a low-pressure user input is received, the electronic device may display a bar-shaped object (or handler or UI) related to the user interface. According to an embodiment, the low-pressure user input may be a touch input or a swipe input in the first direction (e.g., swipe front).

According to an embodiment, the electronic device may display the user interface based on identifying that the pressure value is equal to or greater than the first value while the object is displayed.

By displaying an object related to the user interface based on a low-pressure user input in this way, information about a function to be executed may be provided in advance.

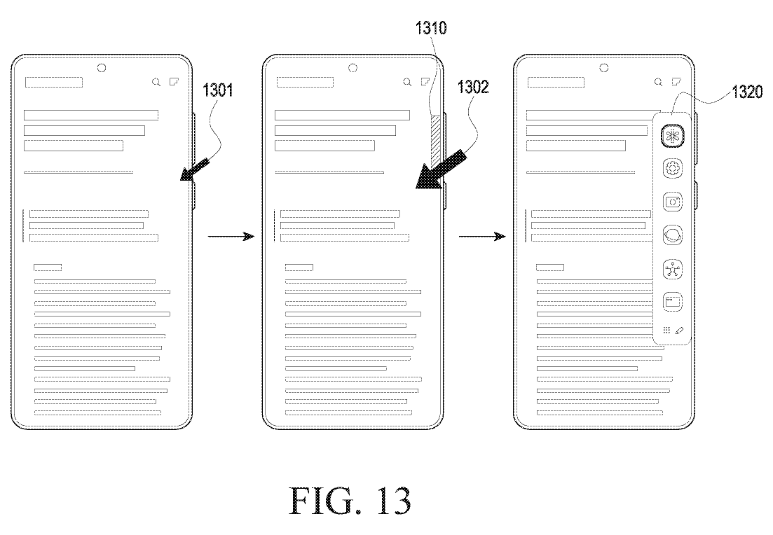

According to an embodiment, the operation of displaying an object related to the user interface based on a low-pressure user input is described below in more detail with reference to FIG. 13.

According to an embodiment, the electronic device may select a function performed by a high user input with a pressure value equal to or greater than the first value through a low-pressure user input with a pressure value less than the first value and equal to or greater than the second value. For example, the electronic device may change the function to be executed each time a low- user input is received and change and display an object corresponding to the function to be executed. According to an embodiment, the electronic device may perform a function corresponding to the object displayed when a high-pressure user input is performed.

For example, the electronic device may display a first object related to a first function corresponding to the first application and the user input based on the pressure value of the user input being less than the first value and equal to or greater than the second value. For example, the first function corresponding to the first application and the user input may not be a function displaying a user interface (e.g., edge panel) including at least one icon each corresponding to at least one function.

According to an embodiment, the electronic device may display a second object related to a second function different from the first function based on receiving a second user input that is a swipe input in the first direction while the first object is displayed. According to an embodiment, the second function may be a function displaying a user interface (e.g., edge panel) including at least one icon each corresponding to at least one function.

According to an embodiment, the electronic device may display the user interface corresponding to the second function based on identifying that the pressure value is equal to or greater than the first value while the second object is displayed.

As such, a user may select a desired function through a swipe input through the input unit.

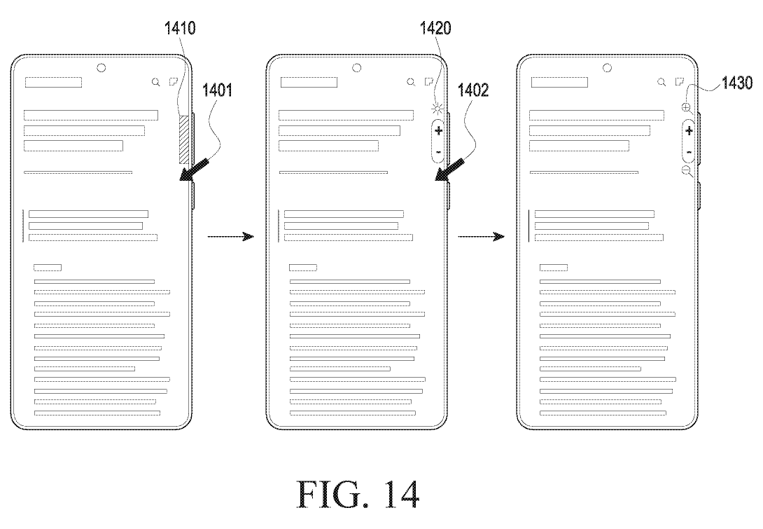

According to an embodiment, the operation of changing a function to be executed through a swipe input is described below in more detail with reference to FIG. 14.

According to an embodiment, when the user interface includes multiple layers, the electronic device may terminate the display of the first layer and display a second layer that is a lower layer of the first layer based on receiving a second user input that is a swipe input in the first direction while the first layer of the user interface is displayed. As such, the electronic device may select a layer including a function that the user wants to use through repeated swipe inputs in the first direction.

According to an embodiment, the electronic device may delete the user interface based on receiving a user input with a swipe direction in the second direction opposite to the first direction while the user interface is displayed.

According to an embodiment, the displayed user interface may have its display terminated in the form of moving outside the display area based on a swipe input (e.g., swipe back).

According to an embodiment, the electronic device may determine a function to be executed based on the swipe input based on the first application being executed when the swipe input is received and the swipe direction. For example, when the execution screen of the first application is a home screen, AOD screen, or lock screen, the electronic device may display a user interface including at least one icon based on a swipe input in the first direction (e.g., swipe front). For example, when the execution screen of the first application is a home screen, AOD screen, or lock screen, the electronic device may display a user interface related to a payment function based on a swipe input in the third direction (e.g., swipe up). For example, when the execution screen of the first application is a home screen, AOD screen, or lock screen, the electronic device may display a user interface including at least one icon for setting changes based on a swipe input in the fourth direction (e.g., swipe down).

According to an embodiment, when the execution screen of the first application is an execution screen of a video application or a music playback application, the electronic device may display a user interface for section search, volume control, or brightness control based on a swipe input in the third direction (e.g., swipe up) or the fourth direction (e.g., swipe down).

According to an embodiment, the electronic device may further include a haptic actuator (e.g., the haptic actuator 340 of FIG. 3) corresponding to the input unit.

According to an embodiment, the electronic device may control the haptic actuator to provide vibration with intensity and pattern related to a first function corresponding to the first application and the user input.

According to an embodiment, the electronic device may receive a second user input for changing a setting value. For example, the setting value may include volume control or brightness control. According to an embodiment, the electronic device may control the haptic actuator to provide vibration with adjusted intensity based on the setting value changed based on the second user input.

According to an embodiment, the electronic device may control the haptic actuator to provide vibration with intensity and pattern corresponding to stored heart rate based on execution of a heart rate-related application.

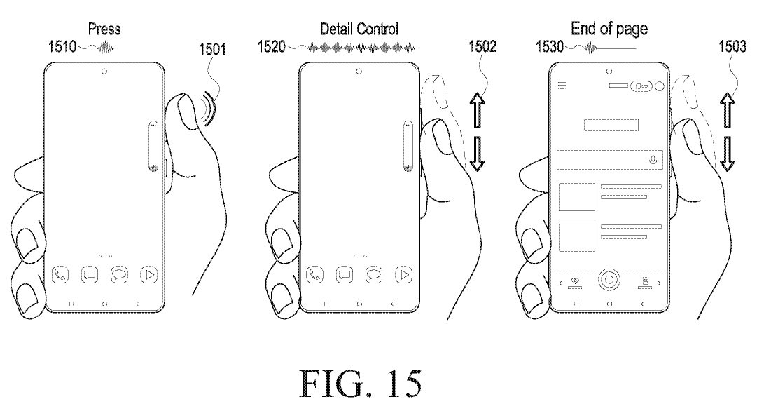

According to an embodiment, the operation of providing vibration feedback through the haptic actuator is described below in more detail with reference to FIGS. 15, 16, and 17.

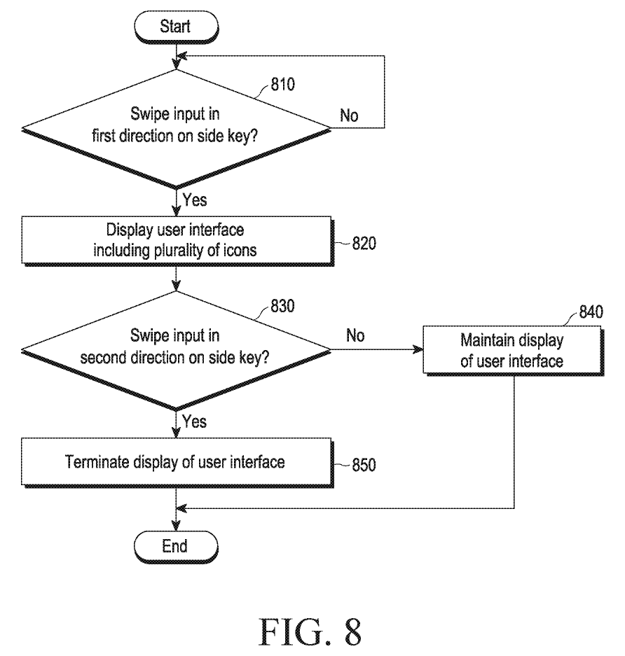

FIG. 8 is a flowchart illustrating an operation of an electronic device according to a direction of a swipe input received on a key on a side surface of the electronic device according to an embodiment of the disclosure.

Referring to FIG. 8, in operation 810, an electronic device (e.g., the electronic device 101 of FIG. 1 or the processor 120 of FIG. 1) may identify whether there is a swipe input in a first direction on a side key (e.g., the first input unit 210 of FIG. 2 or the second input unit 220 of FIG. 2).

According to an embodiment, the electronic device may identify whether a swipe input in the first direction is received on a side key disposed in the housing on a side surface of the electronic device while displaying a home screen, AOD screen, lock screen, or execution screen of a specific application. For example, the swipe input in the first direction may be a swipe front (e.g., the swipe front 710 of FIG. 7), which is a swipe in a direction from the rear of the electronic device toward the front of the electronic device.

According to an embodiment, the electronic device may identify that the first swipe input is received when the pressure of the swipe input in the first direction is equal to or greater than a first value, and may identify that the first swipe input is not received when the pressure of the swipe input in the first direction is less than the first value.

According to an embodiment, if the swipe input in the first direction is not received (operation 810 - No), the electronic device may repeat operation 810.

According to an embodiment, if the swipe input in the first direction is received (operation 810 - Yes), in operation 820, the electronic device may display a user interface including a plurality of icons. For example, the plurality of icons may respectively correspond to a plurality of functions. The plurality of functions may be execution of a specific application or execution of a function of a specific application (e.g., screen capture or music playback).

According to an embodiment, the electronic device may display the user interface in the form in which the user interface is located outside the display and enters into the display based on the swipe input.

According to an embodiment, in operation 830, the electronic device may identify whether there is a swipe input in a second direction on the side key.

According to an embodiment, the second direction may be opposite to the first direction. For example, the swipe input in the second direction may be a swipe back (e.g., the swipe back 720 of FIG. 7), which is a swipe in a direction from the front of the electronic device toward the rear of the electronic device.

According to an embodiment, in operation 840, the electronic device may maintain the display of the user interface.

According to an embodiment, in operation 850, the electronic device may terminate the display of the user interface.

According to an embodiment, the electronic device may terminate the display of the user interface in the form in which the displayed user interface moves outside the display.

FIG. 9 is a view illustrating an operation of an electronic device according to a direction of a swipe input received on a key on a side surface of the electronic device according to an embodiment of the disclosure.

Referring to FIG. 9, an electronic device (e.g., the electronic device 101 of FIG. 1 or the processor 120 of FIG. 1) may receive a swipe input 901 (e.g., swipe front) in a first direction from the rear to the front of the electronic device through an input unit (e.g., the first input unit 210 of FIG. 2 or the second input unit 220 of FIG. 2) disposed in the housing on a side surface of the electronic device while an execution screen 910 of a first application is displayed.

According to an embodiment, based on receiving the swipe input 901 in the first direction, the electronic device may display a user interface 920 including at least one icon each corresponding to at least one function. According to an embodiment, the electronic device may display an indicator indicating that a first icon 921 included in the user interface 920 is an icon to be selected. For example, the first icon 921 may be an icon located at the uppermost end of the user interface 920.

According to an embodiment, the electronic device may receive a swipe input 902 (e.g., swipe up and/or swipe down) in a third direction toward the upper end and/or a fourth direction toward the lower end through the input unit while the user interface 920 is displayed. According to an embodiment, the electronic device may move the position of the indicator to a second icon 922 based on the swipe input 902 in the third direction and/or the fourth direction.

According to an embodiment, the electronic device may receive a user input 903 (e.g., touch, double touch, press, long press, or double press) for selecting the second icon 922 through the input unit while the indicator is displayed on the second icon 922. According to an embodiment, the movement of the indicator may be performed based on a swipe input in the third direction and/or the fourth direction through the first input unit (e.g., the first input unit 210 of FIG. 2) among the input units, and the selection of an icon may be performed through the second input unit (e.g., the second input unit 220 of FIG. 2) among the input units. According to an embodiment, the indicator movement operation and icon selection operation may also be performed through a single input unit.

According to an embodiment, based on receiving the user input 903 for selecting the second icon 922, the electronic device may display an execution screen 930 of an application corresponding to the second icon 922.

According to an embodiment, when displaying the execution screen 930 of the application corresponding to the second icon 922, the electronic device may terminate the display of the user interface 920.

FIG. 10 is a view illustrating an operation of an electronic device according to a direction of a swipe input received on a key on a side surface of the electronic device while an AOD screen is displayed according to an embodiment of the disclosure.

Referring to FIG. 10, an electronic device (e.g., the electronic device 101 of FIG. 1 or the processor 120 of FIG. 1) may receive a swipe input 1001 (e.g., swipe front) in a first direction from the rear to the front of the electronic device through an input unit (e.g., the first input unit 210 of FIG. 2 or the second input unit 220 of FIG. 2) disposed in the housing on a side surface of the electronic device while an AOD screen 1010 is displayed.

According to an embodiment, based on receiving the swipe input 1001 in the first direction, the electronic device may display a user interface 1020 including at least one icon each corresponding to at least one function. According to an embodiment, the electronic device may display an indicator indicating that a first icon 1021 included in the user interface 1020 is an icon to be selected. For example, the first icon 1021 may be an icon located at the uppermost end of the user interface 1020.

According to an embodiment, when badge display is allowed for icons, the electronic device may display update status of applications (e.g., SNS application, message application, phone application) that have received recent notifications among icons included in the user interface 1020 as badges. When badge display is not allowed for icons, the electronic device may display an icon list through the user interface 1020.

According to an embodiment, the electronic device may receive a swipe input 1002 (e.g., swipe up and/or swipe down) in a third direction toward the upper end and/or a fourth direction toward the lower end through the input unit while the user interface 1020 is displayed. According to an embodiment, the electronic device may move the position of the indicator to a second icon based on the swipe input 1002 in the third direction and/or the fourth direction.

According to an embodiment, when a user input for selecting an icon with the indicator displayed is received after moving the indicator through the swipe input 1002 in the third direction and/or the fourth direction, the electronic device may identify whether the AOD screen is a lock screen.

According to an embodiment, when the AOD screen is a lock screen, the electronic device may display a screen for unlocking when an icon is selected. The electronic device may perform a function corresponding to the selected icon when unlocked. According to an embodiment, the unlocking operation is described below in more detail with reference to FIGS. 11A and 11B.

According to an embodiment, when the AOD screen is not a lock screen, the electronic device may perform a function corresponding to the selected icon when an icon is selected. For example, when the icon is for executing a specific application, the electronic device may display an execution screen of the application corresponding to the selected icon.

FIG. 11A is a view illustrating an operation of an electronic device according to a direction of a swipe input received on a key on a side surface of the electronic device in a locked state according to an embodiment of the disclosure.

Referring to FIG. 11A, an electronic device (e.g., the electronic device 101 of FIG. 1 or the processor 120 of FIG. 1) may display a user interface 1120 including at least one icon each corresponding to at least one function based on receiving a swipe input (e.g., swipe front) in a first direction from the rear to the front of the electronic device through an input unit (e.g., the first input unit 210 of FIG. 2 or the second input unit 220 of FIG. 2) disposed in the housing on a side surface of the electronic device while a lock screen 1110 is displayed. According to an embodiment, the electronic device may display an indicator indicating that a first icon 1121 included in the user interface 1120 is an icon to be selected.

According to an embodiment, based on receiving a user input 1101 for selecting the first icon 1121 where the indicator is located, the electronic device may display a screen 1130 for unlocking. For example, the screen 1130 for unlocking may include a guide for unlocking (e.g., pattern input request message, fingerprint input request message, or password input request message).

According to an embodiment, the electronic device may unlock and perform a function corresponding to the selected first icon 1121 based on inputting a plurality of swipe inputs 1102 in a set order through the input unit. For example, when the first icon 1121 is an icon for executing a specific application, the electronic device may display an execution screen 1140 of the application corresponding to the first icon 1121.

According to an embodiment, the setting of the plurality of swipe input directions for unlocking may be performed through a setting screen as illustrated in FIG. 11B below.

FIG. 11B is a view illustrating a screen for setting a swipe direction of a key on a side surface of an electronic device for unlocking the electronic device according to an embodiment of the disclosure.

Referring to FIG. 11B, the electronic device may receive a user input for setting a pattern of swipe input directions using a side button through a lock screen setting screen 1150. For example, the electronic device may identify directions 1151 of a plurality of swipe inputs through the input unit and set the directions 1151 of the plurality of swipe inputs as a pattern for unlocking through the input unit.

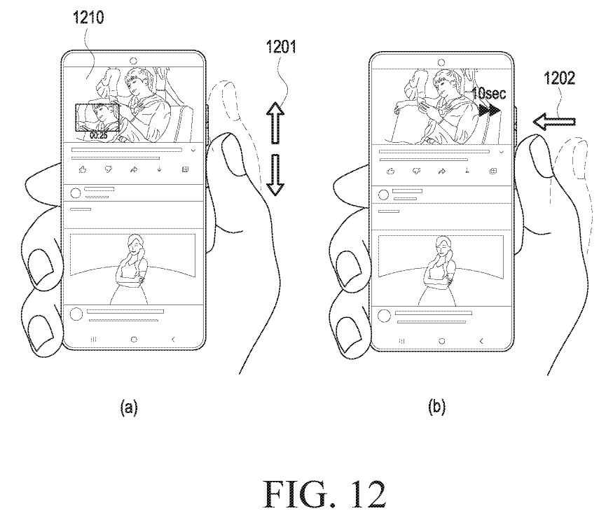

FIG. 12 is a view illustrating an operation of an electronic device according to a user input received on a key on a side surface of the electronic device during video playback according to an embodiment of the disclosure.

Referring to FIG. 12, an electronic device (e.g., the electronic device 101 of FIG. 1 or the processor 120 of FIG. 1) may perform a function corresponding to a user input based on receiving a user input through an input unit (e.g., the first input unit 210 of FIG. 2 or the second input unit 220 of FIG. 2) disposed in the housing on a side surface of the electronic device while an execution screen 1210 of a media application (e.g., video application or music playback application) is displayed.

According to an embodiment, as illustrated in FIG. 12(a), when receiving a swipe input 1201 (e.g., swipe up and/or swipe down) in a third direction toward the upper end and/or a fourth direction toward the lower end through the input unit while the execution screen 1210 of the media application is displayed, the electronic device may perform a playback section search of content. According to an embodiment, while fine selection can be difficult when selecting a playback section through a content playback progress bar, the electronic device of the disclosure can enable quick selection of a desired playback section by finely moving the playback section back and forth through a swipe 1201 operation.

According to an embodiment, as illustrated in FIG. 12(b), the electronic device may move the content playback section forward by n seconds (e.g., 10 seconds) based on receiving a double touch (or double tap) 1202 through the input unit while the execution screen of the media application is displayed.

FIG. 13 is a view illustrating an operation of an electronic device according to a pressure value of a swipe input received on a key on a side surface of the electronic device according to an embodiment of the disclosure.

Referring to FIG. 13, an electronic device (e.g., the electronic device 101 of FIG. 1 or the processor 120 of FIG. 1) may overlay and display an object 1310 (e.g., a bar-shaped object) related to a function based on the first application and the user input 1301 on a partial area of the execution screen of the first application based on receiving a low-pressure user input 1301 through an input unit (e.g., the first input unit 210 of FIG. 2 or the second input unit 220 of FIG. 2) disposed in the housing on a side surface of the electronic device while the execution screen of the first application is displayed. According to an embodiment, the electronic device may also provide vibration feedback along with the display of the object 1310.

According to an embodiment, the low-pressure user input 1301 may be a user input with pressure lower than a first pressure value for performing a function but greater than a second pressure value, which is a minimum threshold pressure value. According to an embodiment, the low-pressure user input 1301 may be a low-pressure touch or a low-pressure swipe input (e.g., swipe front).

According to an embodiment, the electronic device may execute a function corresponding to the first application and the user input 1302 based on receiving a high-pressure user input 1302 through the input unit while the object 1310 is displayed. For example, when the function corresponding to the first application and the user input 1301 is displaying a user interface 1320 including at least one icon each corresponding to at least one function, the electronic device may display the user interface 1320. For example, the electronic device may overlay and display the user interface 1320 on the execution screen of the first application.

FIG. 14 is a view illustrating an operation of an electronic device providing a user interface related to a function based on a set order according to a swipe input received on a key on a side surface of the electronic device according to an embodiment of the disclosure.

Referring to FIG. 14, an electronic device (e.g., the electronic device 101 of FIG. 1 or the processor 120 of FIG. 1) may change a function to be performed each time a user input 1401, 1402 is received through an input unit (e.g., the first input unit 210 of FIG. 2 or the second input unit 220 of FIG. 2) disposed in the housing on a side surface of the electronic device.

For example, the electronic device may overlay and display a first object 1410 (e.g., a bar-shaped object) related to a first function based on the first application and the user input on a partial area of the execution screen of the first application based on receiving a low-pressure user input through the input unit while the execution screen of the first application is displayed. For example, the first object 1410 may correspond to a function of displaying a user interface including at least one icon each corresponding to at least one function.

According to an embodiment, the electronic device may change the first object 1410 to a second object 1420 related to a second function different from the first function based on receiving a low-pressure user input 1401 while the first object 1410 is displayed. For example, the second object 1420 may correspond to a function of adjusting screen brightness.

According to an embodiment, the electronic device may change the second object 1420 to a third object 1430 related to a third function different from the first and second functions based on receiving a low-pressure user input 1402while the second object 1420 is displayed. For example, the third object 1430 may correspond to a function of controlling screen zoom in/zoom out.

According to an embodiment, the electronic device may change the third object 1430 back to the first object 1410 based on receiving a low-pressure user input 1402 while the second object 1420 is displayed.

According to an embodiment, the electronic device may perform a function corresponding to the object displayed at the time when a high-pressure user input is received based on receiving a high-pressure user input.

As such, a user may select a desired function through a swipe input through the input unit.

FIG. 15 is a view illustrating vibration feedback provided according to a user input received on a key on a side surface of an electronic device according to an embodiment of the disclosure.

Referring to FIG. 15, an electronic device (e.g., the electronic device 101 of FIG. 1 or the processor 120 of FIG. 1) may control a haptic actuator (e.g., the haptic actuator 340 of FIG. 3) to provide vibration feedback 1510, 1520, 1530 corresponding to a user input 1501, 1502, 1503 through an input unit based on receiving the user input 1501 through the input unit (e.g., the first input unit 210 of FIG. 2 or the second input unit 220 of FIG. 2) disposed in the housing on a side surface of the electronic device.

For example, the electronic device may control the haptic actuator to provide a first vibration 1510 with intensity and pattern corresponding to a press input 1501 through the input unit based on receiving the press input 1501 through the input unit.

According to an embodiment, the electronic device may display a user interface indicating an adjusted setting value and control the haptic actuator to provide the first vibration 1510 with intensity and pattern corresponding to the press input 1501 through the input unit based on receiving the press input 1501 for adjusting a setting value (e.g., volume or brightness) through the input unit.

For example, the electronic device may control the haptic actuator to provide a second vibration 1520 with intensity and pattern corresponding to an up-down swipe input 1502 through the input unit based on receiving the up-down swipe input 1502 through the input unit.

According to an embodiment, the electronic device may display a user interface indicating an adjusted setting value and control the haptic actuator to provide the second vibration 1520 with intensity and pattern corresponding to the up-down swipe input 1502 through the input unit based on receiving the up-down swipe input 1502 for adjusting a setting value (e.g., volume or brightness) through the input unit. For example, the second vibration 1520 may be provided with a faster cycle and lower intensity compared to the first vibration 1510.

For example, the electronic device may control the haptic actuator to provide a third vibration 1530 with intensity and pattern corresponding to reaching the upper or lower surface of the page through the input unit based on reaching the upper or lower surface of the page according to receiving an up-down swipe input 1503 through the input unit while displaying a scrollable page. For example, the third vibration 1530 may be a single vibration provided upon reaching the upper or lower surface of the page.

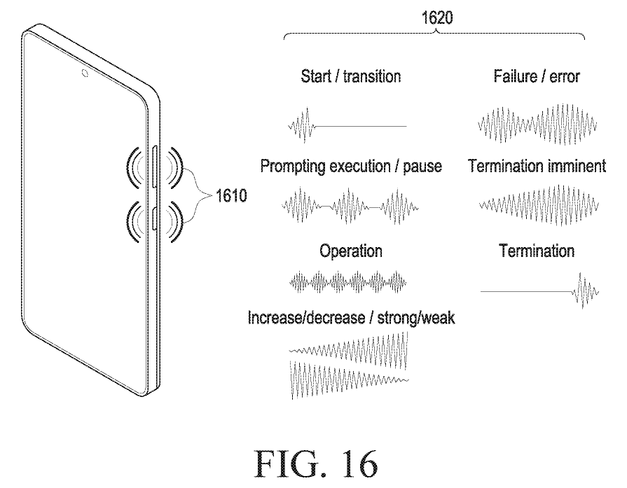

FIG. 16 is a view illustrating vibration feedback provided according to a user input received on a key on a side surface of an electronic device according to an embodiment of the disclosure.

Referring to FIG. 16, an electronic device (e.g., the electronic device 101 of FIG. 1 or the processor 120 of FIG. 1) may provide vibration 1610 through an input unit (e.g., the first input unit 210 of FIG. 2 or the second input unit 220 of FIG. 2). For example, the vibration 1610 may include vibrations 1620 of various intensities and patterns.

For example, the electronic device may control a haptic actuator (e.g., the haptic actuator 340 of FIG. 3) to provide vibrations 1620 of various intensities and patterns for progress, failure, error, and increase/decrease of setting values.

For example, start/transition feedback may be a single vibration feedback provided when starting a function or switching modes to inform that the current function has started or to indicate a ready state before starting. For example, termination phase feedback may be a single vibration feedback provided when terminating a currently executing function. According to an embodiment, the electronic device may provide vibration feedback at an imminent termination phase at specific times such as, for example, a few seconds or minutes before, as feedback suggesting imminent termination just before termination. For example, the electronic device may provide vibration feedback of different intensities according to increase/decrease when adjusting volume, brightness, or scrolling screen pages, and may provide termination phase feedback once when reaching the maximum/minimum point. For example, the electronic device may provide vibration feedback that gradually increases from weak to strong vibration when volume or brightness increases, and provide vibration feedback that decreases from strong to weak vibration when volume or brightness decreases. For example, the electronic device may repeatedly provide fine intensity vibration feedback while performing a swipe operation when scrolling pages or finely adjusting dial-type settings through swipe input. For example, when pausing media functions such as, for example, music, video, or voice recording, the electronic device may repeatedly provide vibration feedback of the same intensity at regular intervals while touching the input unit to notify that the electronic device is paused and encourage execution.

According to an embodiment, the electronic device may also provide vibration feedback with patterns like a bouncing ball or galloping horses. According to an embodiment, the electronic device may provide vibration feedback of different intensities and patterns for each notification based on user settings.

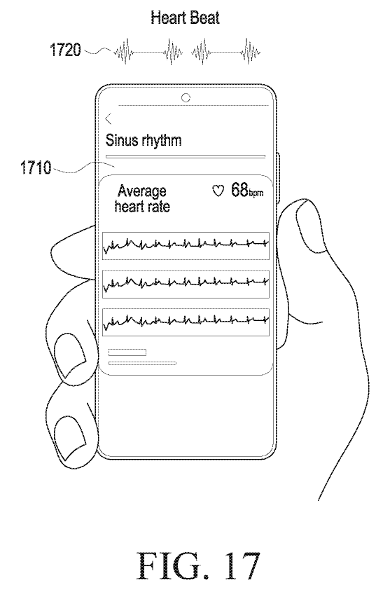

FIG. 17 is a view illustrating an operation of providing vibration corresponding to heart rate information through a key on a side surface of an electronic device according to an embodiment of the disclosure.

Referring to FIG. 17, an electronic device (e.g., the electronic device 101 of FIG. 1 or the processor 120 of FIG. 1) may provide vibration feedback 1720 with intensity and pattern corresponding to stored heart rate through an input unit (e.g., the first input unit 210 of FIG. 2 or the second input unit 220 of FIG. 2) while executing a heart rate-related application 1710 (e.g., health application). For example, the electronic device may provide vibration feedback 1720 corresponding to heart rate through the input unit while a touch is maintained on the input unit. The stored heart rate may be measured by the electronic device or may be measured by an external electronic device (e.g., a wearable electronic device such as, for example, a smartwatch or smart ring) (e.g., the electronic device 104 of FIG. 1) and received from the external electronic device. According to an embodiment, the electronic device may provide vibration feedback corresponding to pre-measured and stored heart rate, or may provide vibration feedback corresponding to heart rate measured in real-time by the electronic device or external electronic device. According to an embodiment, the heart rate may be the user's heart rate or another person's heart rate.

As such, the electronic device may provide an experience of feeling heart rate without looking at the screen by providing vibration feedback with intensity and pattern corresponding to heart rate through the input unit.

According to an embodiment, an electronic device may include a housing having a front surface and at least one side surface, a display mounted on the front surface of the housing, an input unit disposed on the at least one side surface of the housing and configured to receive a user input for touch and pressure, wherein the input unit includes a touch-sensitive surface configured to detect touch location and direction and a pressure-sensitive layer configured to measure applied pressure intensity, at least one processor including processing circuitry, and memory storing executable instructions that, when executed by the at least one processor individually or collectively, cause the electronic device to perform operations.

According to an embodiment, the instructions may be configured to, when executed by the at least one processor individually or collectively, cause the electronic device to display an execution screen of a first application on the display.

According to an embodiment, the instructions may be configured to, when executed by the at least one processor individually or collectively, cause the electronic device to identify a direction of a touch and an intensity of a pressure of the user input as identified information when receiving a user input through the input unit.

According to an embodiment, the instructions may be configured to, when executed by the at least one processor individually or collectively, cause the electronic device to control the execution screen of the first application based on the identified information.

According to an embodiment, the input unit may include a touch sensor configured to sense the touch and a pressure sensor configured to sense the pressure of the touch.

According to an embodiment, the touch sensor and the pressure sensor may be disposed to be stacked.

According to an embodiment, the instructions may be configured to, when executed by the at least one processor individually or collectively, cause the electronic device to identify whether a swipe direction of the user input is a first direction from the input unit toward the display, a second direction opposite to the first direction, a third direction upward from the input unit, or a fourth direction downward from the input unit based on changes in capacitance values of each of the plurality of electrode pads of the touch sensor.

According to an embodiment, the instructions may be configured to, when executed by the at least one processor individually or collectively, cause the electronic device to overlay and display a user interface including at least one icon each corresponding to at least one function on a partial area of the execution screen of the first application based on the swipe direction being the first direction.

According to an embodiment, the instructions may be configured to, when executed by the at least one processor individually or collectively, cause the electronic device to delete the user interface based on receiving a user input with a swipe direction in the second direction while the user interface is displayed.

According to an embodiment, the user interface may further include an indicator indicating an icon to be selected among the at least one icon.

According to an embodiment, the instructions may be configured to, when executed by the at least one processor individually or collectively, cause the electronic device to change the position of the indicator based on the swipe direction being the third direction or the fourth direction.

According to an embodiment, the execution screen of the first application may be an always on display (AOD) screen.

According to an embodiment, the instructions may be configured to, when executed by the at least one processor individually or collectively, cause the electronic device to display the user interface on a partial area of the AOD screen.

According to an embodiment, the execution screen of the first application may be a lock screen.

According to an embodiment, the instructions may be configured to, when executed by the at least one processor individually or collectively, cause the electronic device to display a screen for unlocking based on receiving a user input selecting one icon from the user interface displayed on a partial area of the lock screen.

According to an embodiment, the instructions may be configured to, when executed by the at least one processor individually or collectively, cause the electronic device to unlock the lock screen based on receiving a plurality of swipe inputs in a set order through the input unit.

According to an embodiment, the instructions may be configured to, when executed by the at least one processor individually or collectively, cause the electronic device to display an execution screen of an application for the selected icon.

According to an embodiment, the input unit may further include a pressure sensor.

According to an embodiment, the instructions may be configured to cause, when executed by the at least one processor individually or collectively, the electronic device to display an object related to the user interface based on a pressure value of the user input detected based on the pressure sensor being less than a first value and equal to or greater than a second value.

According to an embodiment, the instructions may be configured to cause, when executed by the at least one processor individually or collectively, the electronic device to display the user interface based on identifying that the pressure value is equal to or greater than the first value while the object is displayed.

According to an embodiment, the instructions may be configured to cause, when executed by the at least one processor individually or collectively, the electronic device to, based on a pressure value of the user input detected based on the pressure sensor being less than a first value and equal to or greater than a second value, display a first object related to a first function corresponding to the first application and the user input.

According to an embodiment, the instructions may be configured to cause, when executed by the at least one processor individually or collectively, the electronic device to display, while the first object is displayed, a second object related to a second function different from the first function based on receiving a second user input that is a swipe input in the first direction.

According to an embodiment, the instructions may be configured to cause, when executed by the at least one processor individually or collectively, the electronic device to display, while the second object is displayed, the user interface corresponding to the second function based on identifying that the pressure value is equal to or greater than the first value.

According to an embodiment, the electronic device may further include a haptic actuator corresponding to the input unit.

According to an embodiment, the instructions may be configured to cause, when executed by the at least one processor individually or collectively, the electronic device to control the haptic actuator to provide vibration with intensity and pattern related to a first function corresponding to the first application and the user input.

According to an embodiment, the instructions may be configured to cause, when executed by the at least one processor individually or collectively, the electronic device to receive a second user input for changing a setting value.

According to an embodiment, the instructions may be configured to cause, when executed by the at least one processor individually or collectively, the electronic device to control the haptic actuator to provide vibration with adjusted intensity based on a setting value changed based on the second user input.

According to an embodiment, the instructions may be configured to cause, when executed by the at least one processor individually or collectively, the electronic device to control, based on execution of a heart rate-related application, the haptic actuator to provide vibration with intensity and pattern corresponding to stored heart rate.

According to an embodiment, a control method of an electronic device may include displaying an execution screen of a first application on a display of the electronic device.

According to an embodiment, the control method of the electronic device may include, when receiving a user input through an input unit of the electronic device, identifying a direction of a touch and an intensity of a pressure of the user input as identified information.

According to an embodiment, the control method of the electronic device may include controlling the execution screen of the first application based on the identified information.

According to an embodiment, the identifying operation may include identifying a pressure value of the user input based on a pressure sensor included in the input unit.

According to an embodiment, the control method of the electronic device may include identifying whether a swipe direction of the user input is a first direction from the input unit toward the display, a second direction opposite to the first direction, a third direction upward from the input unit, or a fourth direction downward from the input unit based on changes in capacitance values of each of a plurality of electrode pads of a touch sensor included in the input unit.

According to an embodiment, the operation of controlling the execution screen of the first application may include overlaying and displaying a user interface including at least one icon each corresponding to at least one function on a partial area of the execution screen of the first application based on the swipe direction being the first direction.

According to an embodiment, the control method of the electronic device may further include deleting the user interface based on receiving a user input with a swipe direction in the second direction while the user interface is displayed.

According to an embodiment, the user interface may further include an indicator indicating an icon to be selected among the at least one icon.

According to an embodiment, the control method of the electronic device may further include changing the position of the indicator based on the swipe direction being the third direction or the fourth direction.

According to an embodiment, the execution screen of the first application may be an always on display (AOD) screen.

According to an embodiment, the operation of overlaying and displaying the user interface on a partial area of the execution screen of the first application may display the user interface on a partial area of the AOD screen.

According to an embodiment, the execution screen of the first application may be a lock screen.

According to an embodiment, the control method of the electronic device may further include displaying a screen for unlocking based on receiving a user input selecting one icon from the user interface displayed on a partial area of the lock screen.

According to an embodiment, the control method of the electronic device may further include unlocking the lock screen based on receiving a plurality of swipe inputs in a set order through the input unit.

According to an embodiment, the control method of the electronic device may further include displaying an execution screen of an application for the selected icon.

According to an embodiment, the control method of the electronic device may further include displaying an object related to the user interface based on a pressure value of the user input detected by the pressure sensor of the input unit being less than a first value and equal to or greater than a second value.

According to an embodiment, the control method of the electronic device may further include displaying the user interface based on identifying that the pressure value is equal to or greater than the first value while the object is displayed.

According to an embodiment, the control method of the electronic device may further include displaying, based on a pressure value of the user input detected by the pressure sensor of the input unit being less than a first value and equal to or greater than a second value, a first object related to a first function corresponding to the first application and the user input.

According to an embodiment, the control method of the electronic device may further include displaying, while the first object is displayed, a second object related to a second function different from the first function based on receiving a second user input that is a swipe input in the first direction.

According to an embodiment, the control method of the electronic device may further include displaying, while the second object is displayed, the user interface corresponding to the second function based on identifying that the pressure value is equal to or greater than the first value.

According to an embodiment, the control method of the electronic device may further include controlling a haptic actuator corresponding to the input unit to provide vibration with intensity and pattern related to a first function corresponding to the first application and the user input.

According to an embodiment, the operation of controlling the haptic actuator may include receiving a second user input for changing a setting value.

According to an embodiment, the operation of controlling the haptic actuator may include controlling the haptic actuator to provide vibration with adjusted intensity based on a setting value changed based on the second user input.

According to an embodiment, the operation of controlling, based on execution of a heart rate-related application, the haptic actuator may control the haptic actuator to provide vibration with intensity and pattern corresponding to stored heart rate.

According to an embodiment, a computer program product may include a non-transitory computer-readable recording medium storing instructions configured to be executed by at least one processor of an electronic device to display an execution screen of a first application on a display of the electronic device. The non-transitory computer-readable recording medium can also be referred to as a non-transitory computer-readable storage medium.

According to an embodiment, the instructions can be configured to cause the electronic device to identify a direction of a touch and an intensity of a pressure of a user input as identified information when receiving the user input through an input unit of the electronic device.

According to an embodiment, the instructions can be configured to cause the electronic device to control the execution screen of the first application based on the identified information.

According to an embodiment, the instructions can be configured to cause the electronic device to identify whether a swipe direction of the user input is a first direction from the input unit toward the display, a second direction opposite to the first direction, a third direction upward from the input unit, or a fourth direction downward from the input unit based on changes in capacitance values of each of a plurality of electrode pads of a touch sensor included in the input unit.

According to an embodiment, the instructions can be configured to cause the electronic device to overlay and display a user interface including at least one icon each corresponding to at least one function on a partial area of the execution screen of the first application based on the swipe direction being the first direction.

According to an embodiment, the instructions can be configured to cause the electronic device to delete the user interface based on receiving a user input with a swipe direction in the second direction while the user interface is displayed.

According to an embodiment, the user interface may further include an indicator indicating an icon to be selected among the at least one icon.

According to an embodiment, the instructions can be configured to cause the electronic device to change the position of the indicator based on the swipe direction being the third direction or the fourth direction.

According to an embodiment, the execution screen of the first application may be an always on display (AOD) screen.

According to an embodiment, the instructions can be configured to cause the electronic device to display the user interface on a partial area of the AOD screen.

According to an embodiment, the execution screen of the first application may be a lock screen.

According to an embodiment, the instructions can be configured to cause the electronic device to display a screen for unlocking based on receiving a user input selecting one icon from the user interface displayed on a partial area of the lock screen.

According to an embodiment, the instructions can be configured to cause the electronic device to unlock the lock screen based on receiving a plurality of swipe inputs in a set order through the input unit.

According to an embodiment, the instructions can be configured to cause the electronic device to display an execution screen of an application for the selected icon.

According to an embodiment, the instructions can be configured to cause the electronic device to display an object related to the user interface based on a pressure value of the user input detected based on the pressure sensor being less than a first value and equal to or greater than a second value.

According to an embodiment, the instructions can be configured to cause the electronic device to display the user interface based on identifying that the pressure value is equal to or greater than the first value while the object is displayed.

According to an embodiment, the instructions can be configured to cause the electronic device to display, based on the pressure sensor being less than a first value and equal to or greater than a second value, a first object related to a first function corresponding to the first application and the user input based on a pressure value of the user input detected.

According to an embodiment, the instructions can be configured to cause the electronic device to display, while the first object is displayed, a second object related to a second function different from the first function based on receiving a second user input that is a swipe input in the first direction.

According to an embodiment, the instructions can be configured to cause the electronic device to display, while the second object is displayed, the user interface corresponding to the second function based on identifying that the pressure value is equal to or greater than the first value.

According to an embodiment, the electronic device may further include a haptic actuator corresponding to the input unit.

According to an embodiment, the instructions can be configured to cause the electronic device to control the haptic actuator to provide vibration with intensity and pattern related to a first function corresponding to the first application and the user input.

According to an embodiment, the instructions can be configured to cause the electronic device to receive a second user input for changing a setting value.

According to an embodiment, the instructions can be configured to cause the electronic device to control the haptic actuator to provide vibration with adjusted intensity based on a setting value changed based on the second user input.

According to an embodiment, the instructions can be configured to cause the electronic device to control, based on execution of a heart rate-related application, the haptic actuator to provide vibration with intensity and pattern corresponding to stored heart rate.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," “at least one of A or B,” "A, B, or C," "at least one of A, B, and C," and “at least one of A, B, or C,” may include all possible combinations of the items enumerated together in a corresponding one of the phrases. As used herein, such terms as "1st" and "2nd," or “first” and "second" may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” "coupled to," "connected with," or “connected to” another element (e.g., a second element), it means that the element may be coupled with the other element directly (e.g., wiredly), wirelessly, or via a third element.

As used herein, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a housing having a front surface and at least one side surface;
a display mounted on the front surface of the housing;
an input unit disposed on the at least one side surface of the housing and configured to receive a user input for touch and pressure, wherein the input unit includes a touch-sensitive surface configured to detect touch location and direction and a pressure-sensitive layer configured to measure applied pressure intensity;
at least one processor including processing circuitry; and
memory storing executable instructions that, when executed by the at least one processor individually or collectively, cause the electronic device to:
display an execution screen of a first application on the display;
when receiving a user input through the input unit, identify a direction of a touch and an intensity of a pressure of the user input as identified information; and
control the execution screen of the first application based on the identified information.

2. The electronic device of claim 1, wherein the input unit includes:
a touch sensor configured to sense the touch; and
a pressure sensor configured to sense the pressure of the touch, and wherein the touch sensor and the pressure sensor are disposed to be stacked.

3. The electronic device of claim 2, wherein the instructions are configured to, when executed by the at least one processor individually or collectively, cause the electronic device to:
identify whether a swipe direction of the user input is a first direction from the input unit toward the display, a second direction opposite to the first direction, a third direction upward from the input unit, or a fourth direction downward from the input unit, based on a change in capacitance value of each of a plurality of electrode pads included in the touch sensor; and
based on the swipe direction being the first direction, overlay and display a user interface including at least one icon corresponding to at least one function respectively on a partial area of the execution screen of the first application.

4. The electronic device of claim 3, wherein the instructions are configured to, when executed by the at least one processor individually or collectively, cause the electronic device to, based on receiving a user input having a swipe direction in the second direction while the user interface is displayed, delete the user interface.

5. The electronic device of claim 3, wherein the user interface further includes an indicator indicating an icon to be selected among the at least one icon, and wherein the instructions are configured to, when executed by the at least one processor individually or collectively, cause the electronic device to change a position of the indicator based on the swipe direction being the third direction or the fourth direction.

6. The electronic device of claim 3, wherein the execution screen of the first application is an always on display (AOD) screen, and wherein the instructions are configured to, when executed by the at least one processor individually or collectively, cause the electronic device to display the user interface on a partial area of the AOD screen.

7. The electronic device of claim 1, wherein the execution screen of the first application is a lock screen, and wherein the instructions are configured to, when executed by the at least one processor individually or collectively, cause the electronic device to:
display a screen for unlocking based on receiving a user input to select one icon from the user interface displayed on a partial area of the lock screen;
unlock the lock screen based on receiving a plurality of swipe inputs in a set order through the input unit; and
display an execution screen of an application corresponding to the selected icon.

8. The electronic device of claim 3, wherein the instructions are configured to, when executed by the at least one processor individually or collectively, cause the electronic device to:
display an object related to the user interface based on a pressure value of the user input detected based on the pressure sensor being less than a first value and equal to or greater than a second value; and
display the user interface based on identifying that the pressure value is equal to or greater than the first value while the object is displayed.

9. The electronic device of claim 3, wherein the instructions are configured to, when executed by the at least one processor individually or collectively, cause the electronic device to:
based on a pressure value of the user input detected based on the pressure sensor being less than a first value and equal to or greater than a second value, display a first object related to a first function corresponding to the first application and the user input;
while the first object is displayed, display a second object related to a second function different from the first function based on receiving a second user input that is a swipe input in the first direction; and
while the second object is displayed, display the user interface corresponding to the second function based on identifying that the pressure value is equal to or greater than the first value.

10. The electronic device of claim 1, further comprising a haptic actuator corresponding to the input unit, wherein the instructions are configured to, when executed by the at least one processor individually or collectively, cause the electronic device to control the haptic actuator to provide vibration with an intensity and a pattern related to a first function corresponding to the first application and the user input.

11. The electronic device of claim 10, wherein the instructions are configured to, when executed by the at least one processor individually or collectively, cause the electronic device to:
receive a second user input for changing a setting value; and
control the haptic actuator to provide vibration with an adjusted intensity based on the setting value changed based on the second user input.

12. The electronic device of claim 10, wherein the instructions are configured to, when executed by the at least one processor individually or collectively, cause the electronic device to control, based on execution of a heart rate-related application, the haptic actuator to provide vibration with an intensity and a pattern corresponding to a stored heart rate.

13. A control method of an electronic device comprising:
displaying an execution screen of a first application on a display of the electronic device;
when receiving a user input through an input unit of the electronic device, identifying a direction of a touch and an intensity of a pressure of the user input as identified information; and
controlling the execution screen of the first application based on the identified information.

14. The control method of claim 13, wherein the identifying includes determining whether a swipe direction of the user input is a first direction from the input unit toward the display, a second direction opposite to the first direction, a third direction upward from the input unit, or a fourth direction downward from the input unit, based on a change in capacitance value of each of a plurality of electrode pads of a touch sensor included in the input unit, and
wherein controlling the execution screen of the first application includes overlaying and displaying a user interface including at least one icon corresponding to at least one function respectively on a partial area of the execution screen of the first application based on the swipe direction being the first direction.

15. The control method of claim 14, wherein the user interface further includes an indicator indicating an icon to be selected among the at least one icon, and the method further comprises changing a position of the indicator based on the swipe direction being the third direction or the fourth direction.

16. The control method of claim 14, further comprising:
displaying the user interface on a partial area of an always on display (AOD) screen, wherein the execution screen of the first application is the AOD screen.

17. The control method of claim 13, wherein the execution screen of the first application is a lock screen, and further comprising:
displaying a screen for unlocking based on receiving a user input to select one icon from the user interface displayed on a partial area of the lock screen;
unlocking the lock screen based on receiving a plurality of swipe inputs in a set order through the input unit; and
displaying an execution screen of an application corresponding to the selected icon.

18. The control method of claim 14, further comprising:
displaying an object related to the user interface based on a pressure value of the user input detected based on the pressure sensor being less than a first value and equal to or greater than a second value; and
displaying the user interface based on identifying that the pressure value is equal to or greater than the first value while the object is displayed.

19. The control method of claim 14, further comprising:
based on a pressure value of the user input detected based on the pressure sensor being less than a first value and equal to or greater than a second value, displaying a first object related to a first function corresponding to the first application and the user input;
while the first object is displayed, displaying a second object related to a second function different from the first function based on receiving a second user input that is a swipe input in the first direction; and
while the second object is displayed, displaying the user interface corresponding to the second function based on identifying that the pressure value is equal to or greater than the first value.

20. A computer program product comprising a non-transitory computer-readable recording medium storing instructions configured to be executed by at least one processor of an electronic device to perform a plurality of operations comprising:
displaying an execution screen of a first application on a display of the electronic device;
when receiving a user input through an input unit of the electronic device, identifying a direction of a touch and an intensity of a pressure of the user input as identified information; and
controlling the execution screen of the first application based on the identified information.
